(19) United States
(12) Patent Application Publication
(10) Pub. No.: US 2007/0186084 A1
(43) Pub. Date: Aug. 9, 2007

(54) Circuit and method for loop control

(75) Inventor: Satoshi Chiba, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/700,114

(22) Filed: Jan. 31, 2007

(30) Foreign Application Priority Data
Feb. 6, 2006 (JP) 2006-028040

(51) Int. Cl. G06F 9/44

(52) U.S. Cl. 712/241

(57) ABSTRACT

A loop control circuit of the present invention includes a program counter for sequentially indicating an address of an instruction, a LSA calculation circuit for calculating a loop start address of a loop start instruction, a LEA calculation circuit for calculating a loop end address of a loop end instruction, an interlock generation circuit for generating an interlock until a pipeline of a loop instruction is completed so as to suspend a pipeline process of the loop end instruction, and a loop end evaluation circuit for setting the program counter to the loop start address according to a result of a comparison between the program counter and the loop end address after the pipeline process of the loop instruction is completed.

### BACKGROUND OF THE INVENTION

1. Field of the Invention

The present invention relates to a circuit and a method for loop control method, and particularly to a circuit and a method for loop control used by a processor for processing an instruction in a pipeline.

2. Description of the Related Art

A processor with pipeline processing mechanism that executes an instruction by pipeline is known among various processors. A pipeline is divided into a plurality of phases (stages) such as fetching, decoding, and execution of instructions. A plurality of the pipelines are overlapped to each other and the process of the next instruction is sequentially started before completing the process of the preceding instruction. Processes are intended to speed up by processing the plurality of instructions simultaneously in this way. A pipeline process is to process a series of phases from the fetch to execution phases for each instruction.

FIGS. 10A and 10B are configuration examples of a general pipeline. A pipeline shown in FIG. 10A is divided into 4 phases (stages), which are IF (Instruction Fetch), DE (DEcode)1, DE2, and EXE (EXEcution). Each phase processed in one clock cycle.

An example of an operation in each phase is described hereinafter in detail. In IF phase, an instruction to be executed is fetched from an instruction memory according to an address indicated by a program counter. In DE1 phase, the program counter is calculated to indicate an address to fetch the next instruction according to the length of the fetched instruction. In DE2 phase, the fetched instruction is decoded to determine the type of a calculation and an operand is retrieved. In EXE phase, the instruction is executed according to the decoded instruction so as to perform various calculations and to access a data memory.

In recent years, a method to increase the number of pipeline phases to respond to operations in high-speed clocks is commonly used. The pipeline of FIG. 10B is an example in which the number of phases is increased to respond to the high-speed operation. The pipeline is divided into 9 phases, which are:IF1, IF2, IF3, DE1, DE2, AC (Address Calculation), EX1, EX2, and EX3.

An example of an operation in each phase is described hereinafter in detail. In IF1 to IF3 phases, one instruction is fetched in 3 cycles. In DE1 and DE2 phases as with FIG. 10A, a program counter is calculated and an instruction is decoded. In AC phase, an address is calculated to access the data memory. In EX1 to EX3, the instruction is executed in one of the 3 cycles, for example in EX3.

On the other hand DSP (Digital Signal Processor) is known as a processor to process a product-sum operation or the like faster than a general purpose microprocessors and to accomplish a function specialized in various applications.

In general, the DSP includes a loop instruction exclusive for processing loops (the loop referred to as a hardware loop instruction or an overhead loop instruction) and a loop control circuit for executing such loop instruction in order to efficiently execute consecutive repetition processes (loop processes). If the input and fetched instruction is a loop instruction, the loop control circuit does not process instructions in order of input, but controls to repeat processes from a first instruction to a last instruction in the loop. A technology related to such loop control is disclosed in U.S. Pat. No. 5,535,348, for example.

FIG. 11 is a view showing a configuration of a processor performing a loop control in the same way as in U.S. Pat. No. 5,535,348. As shown in FIG. 11, a conventional processor 900 includes an instruction memory 901, a fetch circuit 902, a decode circuit 903, a calculation circuit 904, a data memory access circuit 905, a data memory 906, and a loop control circuit 800. The loop control circuit 800 includes a program counter (PC) 801, a LEA (Loop End Address) calculation circuit 811, a LEA register 812, a LSA (Loop Start Address) calculation circuit 821, a LSA register 822, a loop counter (LC) 802, and a loop end evaluation circuit 830.

FIG. 12 is a flowchart showing a conventional loop control method by the conventional processor 900. After the fetch circuit 902 fetches an instruction from the instruction memory 901, the decode circuit 903 decodes the fetched instruction to evaluate whether the instruction is a loop instruction (S901). If the decoded instruction is a loop instruction, the loop counter 802 sets the number of loops specified by the loop instruction as a LC value (S902). Then the LSA calculation circuit 821 calculates LSA and the LEA calculation circuit 811 calculates LEA in an execution phase of the loop instruction (S903). After that, the LSA calculation circuit 821 sets the calculated LSA to the LSA register 822, and the LEA calculation circuit 811 sets the calculated LEA to the LEA register 812 (S904).

If the decoded instruction is not a loop instruction or after setting LSA and LEA in S904, the loop end evaluation circuit 830 evaluates whether the instruction in the loop is currently (S905). If the instruction in the loop is currently executed, a loop end evaluation is performed in S906 and S907. Specifically, the loop end evaluation circuit 830 compares a PC value of the program counter with LEA of the LEA register 812 by a comparator 831 (S906). If the PC value is equal to LEA, the LC value of the loop counter 802 and 0 are compared by a comparator 832 (S907). If the LSA value is not 0, LSA of the LSA register 822 is set to the PC value of the program counter 801 (S908). Then the loop counter 902 decrements the LC value (S909). Decrementing the LC value is to subtract 1 from the LC value.

If the instruction in the loop is evaluated not to be in loop in S905, if the PC value is not equal to LEA in S906, or if the LC value is 0 in S907, the program counter 801 increments the PC value (S910). Incrementing the PC value is to set the PC value to an address of the next instruction.

An example in which each instruction is processed in pipeline by the conventional processor 900 is described hereinafter in detail. FIG. 13 is an example of a program executed here. In this program, after “LOOP 16; (Loop instruction)” and “NOP (NO OPeration); (NOP instruction)”, instructions inside the loop including “inst(instruction)1; (first instruction)”, “inst2; (second instruction)”, and “inst3; (third instruction)” are written, and “inst4; (fourth instruction)” is written after that.

An operand in the instruction indicates the number of loops. In this example it indicates to repeat the instructions in the loop for 16 times. An NOP instruction is an instruction in which processes such as calculation and memory access are not executed. The NOP instruction is a delay slot instruction for delaying to execute the instructions in the loop. The NOP instruction is written to adjust a timing to execute the instructions in the loop and a timing to determine addresses of the instructions in the loop. One NOP instruction delays the execution of the instructions in the loop for 1 clock cycle.

Subsequent to the loop instruction, instructions in the parentheses “{ }” is the instructions in the loop that are executed repeatedly. The instruction written first in the instructions in the loop is referred to as a loop start instruction. The instruction written last in the instructions in the loop is referred to as a loop end instruction. Specifically, this program repeatedly executes the first to the third instructions for 16 times, and then the fourth instruction.

When the loop instruction is complied, the number of loops and an address of the loop end instruction (offset value) are included in the machine language of the loop instruction. An address of the loop start instruction is not included in the machine language, but is calculated by the processor while processing the loop instruction.

A case of applying the pipeline of FIG. 10A to the conventional processor 900 is considered hereinafter. When executing the program of FIG. 13 in such case, the pipeline will be the one shown in FIG. 14.

Pipeline of 4 phases, which are IF, DE1, DE2, and EXE, of a loop instruction is processed from clock cycles “1 to 4”. Pipeline of the NOP instruction is processed from clock cycles “2 to 5”. Then the first to the third instructions are sequentially processed.

After the loop instruction is decoded in DE2 phase of the loop instruction in clock cycle “3”, LSA/LEA are calculated in EXE phase of the loop instruction in clock cycle “4” (S903). Then LSA/LEA are set to the LSA register 822/LEA register 812 at a timing when proceeding from the clock cycle 4 to 5 (S904).

At this time, the PC value at clock cycle “4”, which is in the EXE phase of the loop instruction, is set to LSA. The PC value at clock cycle “4” is an address of the first instruction that is delayed one cycle by the NOP instruction. The address of the first instruction is set to LSA. An address included in the machine language code of the loop instruction is set to LEA. An address of the third instruction is set to LEA.

If LSA and LEA are set, a loop end evaluation is performed. In clock cycle “5”, the PC value is evaluated (S906). As the PC value is the address of the second instruction and is not equal to LEA, the PC value is incremented (S910). In clock cycle “5”, the PC value is evaluated (S906). As the PC value is the address of the second instruction and is not equal to LEA, the PC value is incremented (S910). In clock cycle “6”, the third instruction following the second instruction is decoded.

In clock cycle “6”, the PC value is evaluated (S906). As the PC value is the address of the third instruction that is equal to LEA, the LC value is evaluated (S907). Since the LC value is not 0, the PC value is set to the address of the first instruction, which is LSA (S908), and then the LC value is decremented (S909). The first instruction is decoded in clock cycle “7”.

If the pipeline processes of the first to the third instructions are repeated for 16 times, the PC value is evaluated in clock cycle “51” (S906). As the PC value is the address of the third instruction that is equal to LEA, the LC value is evaluated (S907). Since the LC value is 0, it is a loop end. Then the PC value is incremented (S910), and the next instruction, the fourth instruction, of the instruction in the loop, is decoded in clock cycle “52”.

A case of applying the pipeline of FIG. 10B to the conventional processor 900 is considered hereinafter. Executing the program of FIG. 13 in such case, the pipeline will be the one shown in FIG. 15.

A pipeline of 9 phases, which are IF1 to IF3, DE1, DE2, AC, and EX1 to EX3 of the loop instruction, are processed from clock cycles “1 to 9”. The pipeline of the NOP instruction is processed from clock cycles “2 to 10”. Then the first to the third instructions are sequentially processed.

Assuming that the phase in which the instruction is actually executed is EX3 and operating in the same way as FIG. 14, LSA/LEA are calculated and set in EX3 phase. After the loop instruction is decoded in clock cycle “5”, LSA/LEA are calculated in EX3 phase of the instruction in clock cycle “9” (S903). Then LSA/LEA are set to the LSA register/LEA register (S904).

In EX3 phase of the loop instruction in clock cycle “9”, specifically before setting LEA, the loop end instruction indicated by LEA (DE2) is processed. Thus when the LEA is set, the next instruction in the instructions in the loop, which is the fourth instruction, is already decoded, and it is not possible to return to the loop start instruction after the loop end instruction to repeat the instructions in the loop. Specifically, it has been a program that an accurate loop end evaluation cannot be performed if the PC value is LEA. Therefore, the instructions in the loop are not executed repeatedly.

As described in the foregoing, it has now been discovered that by the conventional loop control method, if the configuration of the pipeline changes to respond to high-speed operation or the like, the loop end instruction is executed before setting LEA, thereby disabling to accurately perform a loop end evaluation and to repeatedly execute the instructions in the loop.

It is possible to adjust the timing to perform the loop end evaluation by adding the NOP instruction in the program to be executed depending on the number of pipeline phases between the loop instruction and the instructions in the loop. However it is not preferable because it requires a modification of a program, thereby increasing a burden of a user creating the program and also increasing a size of the instruction code.

### SUMMARY OF THE INVENTION

According to an aspect of the present invention, there is provided a loop control circuit to control to repeatedly execute from a loop start instruction to a loop end instruction according to a loop instruction in a processor to process an instruction in a pipeline. The loop control circuit includes: an interlock generation circuit to suspend a pipeline process of the loop end instruction until a pipeline process of the loop instruction is completed, and a loop end evaluation circuit to take a loop end evaluation when the pipeline process of the loop end instruction is executed.

This loop control circuit generates an interlock until the execution of the loop instruction is completed. Thus the loop end evaluation can be performed after executing the loop instruction, thereby enabling to accurately perform the loop end evaluation.

According to another aspect of the present invention, there is provided a loop control circuit to control to repeatedly execute from a loop start instruction to a loop end instruction according to a loop instruction in a processor to process an instruction in a pipeline. The loop control circuit includes a program counter to sequentially indicate an address of an instruction to be processed in pipeline, a loop end address calculation circuit to calculate a loop end address, the loop end address being an address of the loop end instruction, and an interlock generation circuit to generate an interlock according to a result of the comparison between the program counter and the loop end address until a completion of the pipeline process of the loop instruction so as to suspend the pipeline process of the loop end instruction.

This loop control circuit generates the interlock until the execution of the loop instruction is completed. Thus the loop end evaluation can be performed after executing the loop instruction, thereby enabling to accurately perform the loop end evaluation.

According to another aspect of the present invention, there is provided a loop control method to control to repeatedly execute from a loop start instruction to a loop end instruction according to a loop instruction in a processor to process an instruction in a pipeline. The loop control circuit includes generating an interlock to suspend a pipeline process of the loop end instruction until a pipeline process of the loop instruction is completed.

With this loop control method, the interlock is generated until the execution of the loop instruction is completed. Thus the loop end evaluation can be performed after executing the loop instruction, thereby enabling to accurately perform the loop end evaluation.

According to another aspect of the present invention, there is provided a loop control method to control to repeatedly execute from a loop start instruction to a loop end instruction according to a loop instruction in a processor to process an instruction in a pipeline. The loop control method includes indicating sequentially an address of an instruction to be processed in pipeline by a program counter, calculating a loop end address, the loop end address being an address of the loop end instruction, and generating an interlock to suspend a pipeline process of the loop end instruction according to a result of the comparison between the program counter and the calculated loop end address until a pipeline process of the loop instruction is completed.

This loop control method generates the interlock until the execution of the loop instruction is completed. Thus the loop end evaluation can be performed after executing the loop instruction, thereby enabling to accurately perform the loop end evaluation.

The present invention provides a circuit and a method for loop control which are able to accurately evaluate a loop even with different pipeline configurations.

### BRIEF DESCRIPTION OF THE DRAWINGS

The above and other objects, advantages and features of the present invention will be more apparent from the following description taken in conjunction with the accompanying drawings, in which:

FIG. 1 is a configuration diagram showing a processor according to the present invention;

FIG. 2 is a flowchart showing a loop control method according to the present invention;

FIG. 3 is a view showing an example of executing a loop instruction by a processor according to the present invention;

FIG. 4 is a configuration diagram showing the processor according to the present invention;

FIG. 5 is a flowchart showing a loop control method according to the present invention;

FIG. 6 is a flowchart showing an interlock check method according to the present invention;

FIG. 7 is a view showing an example of executing a loop instruction by the processor according to the present invention;

FIG. 8 is a view showing an example of a program for a loop instruction

FIG. 9 is a view showing an example of executing a loop instruction by the processor according to the present invention;

FIGS. 10A and 10B are views showing configuration examples of pipelines;

FIG. 11 is a configuration diagram showing a processor according to a conventional technique;

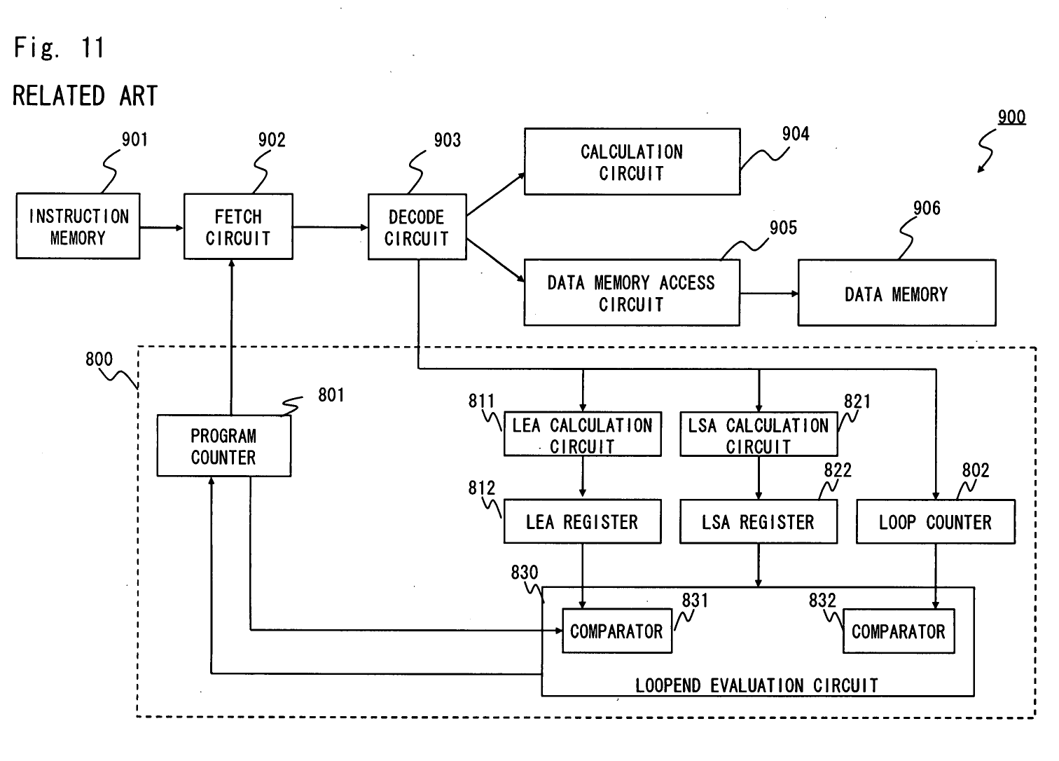

FIG. 12 is a flowchart showing a loop control method according to a conventional technique;

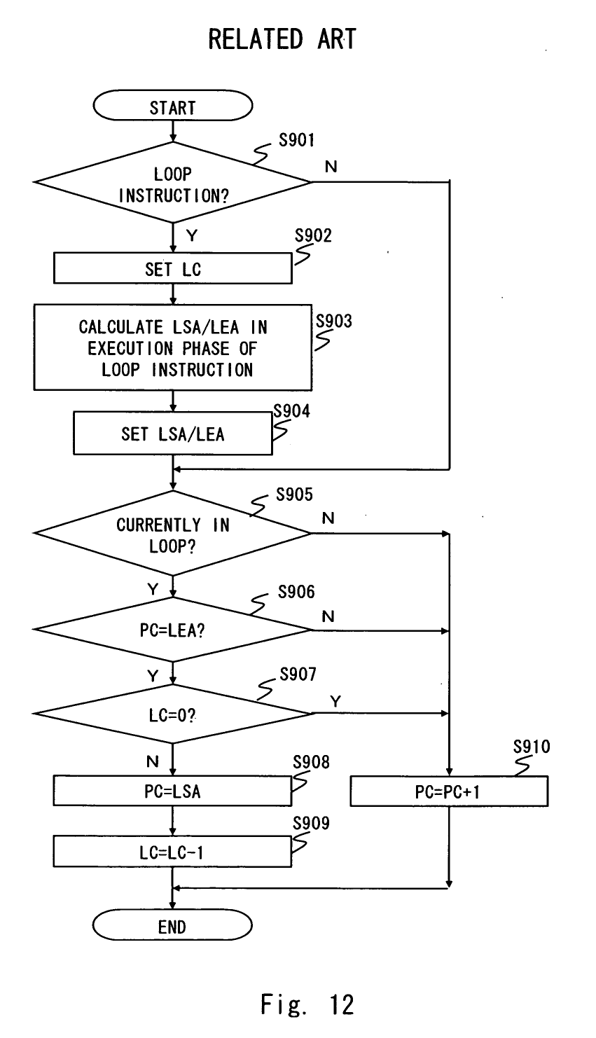

FIG. 13 is a view showing an example of a program of a loop instruction;

FIG. 14 is a view showing an execution example of a loop instruction by a processor according to a conventional technique; and

FIG. 15 is a view showing an execution example of a loop instruction by a processor according to a conventional technique.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

A processor according to a first embodiment of the present invention is described hereinafter in detail. The processor of this embodiment interlocks a loop instruction until an execution of a loop instruction is completed to suspend an execution of the loop start instruction and starts executing the loop start instruction after completing the execution of the loop instruction.

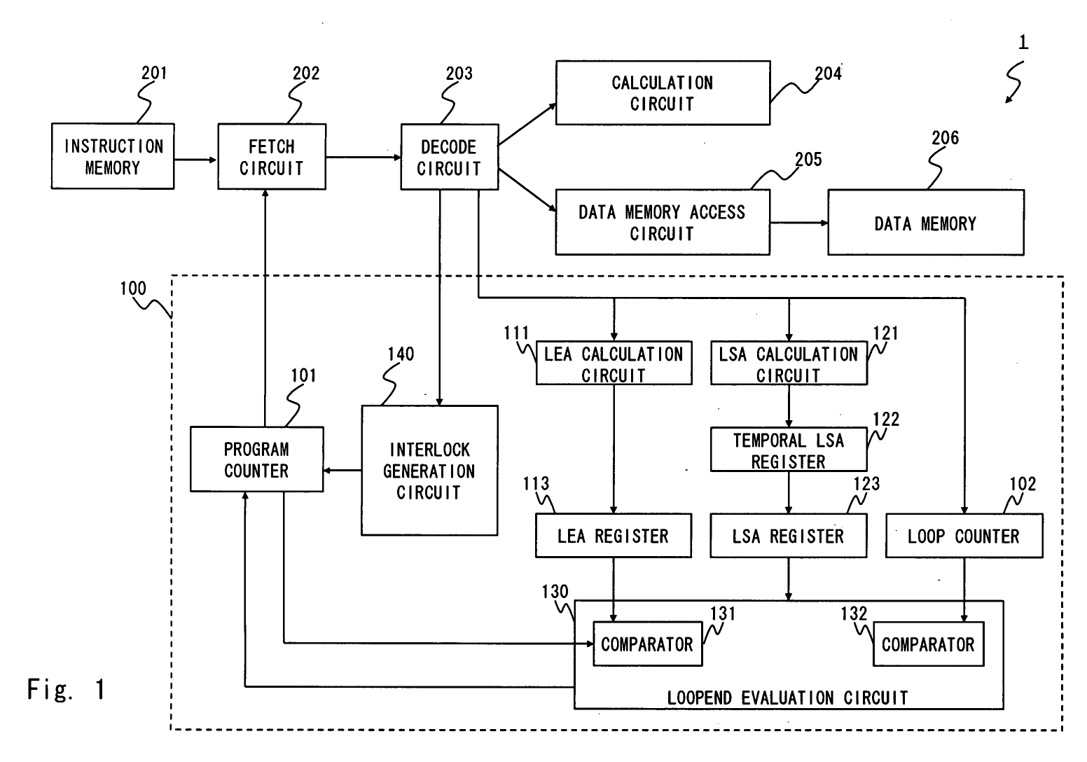

A configuration of the processor of this embodiment is described hereinafter in detail with reference to FIG. 1. The processor 1 is for example a processor to process an instruction in a pipeline and is a DSP capable of executing a loop instruction. As shown in FIG. 1, the processor 1 includes an instruction memory 201, a fetch circuit 202, a decode circuit 203, a calculation circuit 204, a data memory access circuit 205, a data memory 206, and a loop control circuit 100. The loop control circuit 100 includes a program counter 101, a LEA calculation circuit 111, a LEA register 113, a LSA calculation circuit 121, a temporary LSA register 122, a LSA register 123, a loop counter 102, a loop end evaluation circuit 130, and an interlock generation circuit 140.

An instruction to be executed is previously stored to the instruction memory 201. The instruction is machine language code obtained as a result of compiling a program written by a user.

The fetch circuit 202 fetches (reads) an instruction from the instruction memory 201. The program counter 101 sequentially indicates addresses of instructions to be processed in pipeline. The fetch circuit 202 fetches the instructions of the addresses indicated by the program counter 101. Specifically the fetch circuit 202 executes processes in fetch phases (IF phase, and IF1 to IF3 phases) of the pipeline. For example the fetch circuit 202 is a buffer in FIFO (First In First OUT). The fetch circuit 202 outputs fetched instructions to the decode circuit 203 in order of input.

The decode circuit 203 calculates the program counter and decodes for the instructions fetched by the fetch circuit 202. Specifically, the decode circuit 203 executes processes of decode phases (DE1 and DE2 phases) of the pipeline.

The calculation circuit 204 and the data memory access circuit 205 execute processes according to the result of the decoding by the decode circuit 203. Specifically, the calculation circuit 204 and the data memory access 205 execute processes in execution phases (EXE phase and EXE1 to EX3 phases) of the pipeline. The calculation circuit 204 performs various calculations including addition. The data memory 206 is a memory to store the calculation result. The data memory access circuit 205 accesses to the data memory 206 to write/read data.

If the decoded instruction is a loop instruction, the loop control circuit 100 controls to repeat executing instructions from the loop start instruction to the loop end instruction according to the loop instruction. Although not shown, the processor 1 includes a program control circuit for performing branch processes or the like. Further, the loop control circuit 100 may operate as a part of the program control circuit.

The loop counter 102 indicates the number of loops to repeat the instructions in the loop. A LC value of “the number of loops−1” that is specified to the operand of the loop instruction is set to the loop counter 102. The LC value is decremented for each loop.

The LSA calculation circuit (the first loop address calculation circuit) 121 calculates LSA in the pipeline process of the loop instruction. Especially the LSA calculation circuit 121 calculates LSA before the execution phase of the loop instruction, specifically in a phase following the decode phase (i.e. AC phase) of the loop instruction. The LSA calculation circuit 121 takes the PC value at AC phase of the instruction as LSA. The calculation of LSA is not limited in AC phase, but may be any pipeline phase included in the pipeline phase of the loop instruction which is processed at a timing when the address of the loop start instruction is set to the program counter.

The temporary register 122 holds LSA calculated by the LSA calculation circuit 121 till the execution phase of the loop instruction. The temporary register 123 holds LSA held by the temporary register 122 after completing the execution phase of the loop execution.

The LEA calculation circuit (loop end address calculation circuit) 111 calculates LEA during the pipeline process of the loop instruction. The LEA calculation circuit 111 calculates LEA from the phase following the decode phase (i.e. AC phase) to the execution phase (EX3 phase) of the loop instruction. For example the LEA calculation circuit 111 calculates LEA in the execution phase of the loop instruction. An address (offset value) included in the machine language code of the decoded instruction is set to the LEA calculation circuit 111. The offset value is set by a complier or the like while compiling a program.

The LEA register 113 holds LEA calculated by the LEA calculation circuit 111 after completing the execution phase of the loop instruction.

The loop evaluation circuit (loop end evaluation circuit) 130 performs a loop end evaluation (loop end evaluation) whether the repetition of the instruction in the loop ends. The loop end evaluation includes an evaluation whether the current process has reached the loop end instruction, specifically whether the PC value is equal to LEA (PC value evaluation), and an evaluation whether the number of loops has reached the number specified by the loop instruction, specifically whether the LC value is equal to 0 (LC value evaluation). The comparator 131 compares the PC value with LEA of the LEA register 113. The comparator 132 compares the LC value of the loop counter 102 with 0.

The interlock generation circuit 140 generates an interlock from the phase (AC phase) following the decode phase to the end of the execution phase (EX3 phase) in the pipeline of the loop instruction so as to suspend the pipeline process of the loop start instruction. Specifically in this embodiment, by suspending the process of the loop start instruction by the interlock, the pipeline process of the loop end instruction is suspended until the pipeline process of the loop instruction is completed. The interlock here is to stop incrementing the PC value of the program counter 101 to keep the current PC value. With the PC value unchanged, the fetch circuit 202 stops fetching the next instruction. Thus the pipeline process of the next instruction will not be executed.

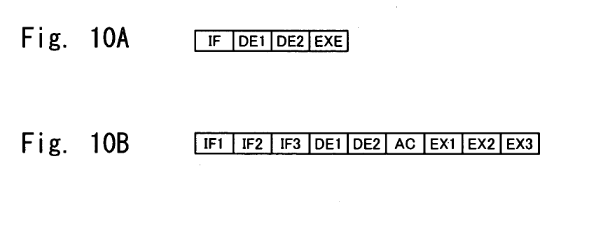

If the number of pipeline phases increases, for example, the interlock generation circuit 140 generates an interlock with a consideration over a pipeline hazard due to a difference from a precedent pipeline. The period of the interlock is previously specified by a designer in hardware design. When changing from the pipeline of FIG. 10A to the pipeline of FIG. 10B, the execution phase (EX3 phase) moves 4 cycles after the decode phase (DE2 phase). Thus the period of the interlock is 4 cycles.

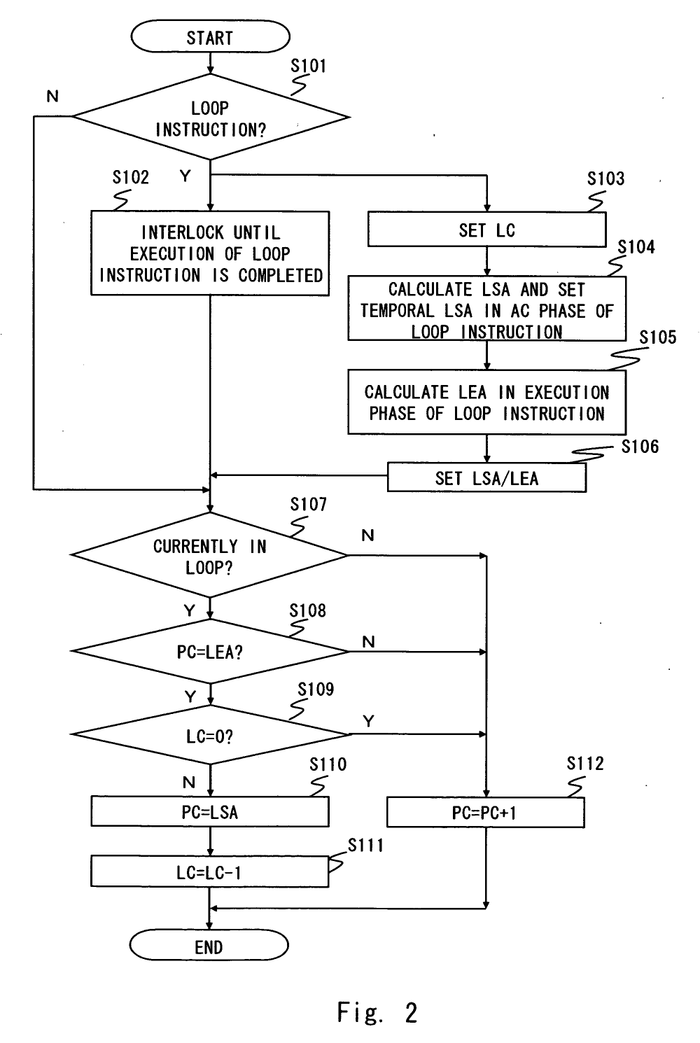

A loop control method by the processor of this embodiment is described hereinafter in detail with reference to FIG. 2. When the fetch circuit 202 fetches an instruction from the instruction memory 202, the decode circuit 203 decodes the fetched instruction to evaluate whether the fetched instruction is a loop instruction (S101).

If the decoded instruction is evaluated to be the loop instruction in S101, the interlock generation circuit 140 interlocks till the execution phase of the loop instruction is completed (S102). This suspends the execution of the loop start instruction until the execution of the loop instruction is completed.

If the instruction is a loop instruction in S101, processes from S103 to S106 are performed in parallel to the interlock of S102. Specifically the loop counter 102 sets the number of loops specified by the loop instruction as the LC value (S103). Then in AC phase of the loop instruction, the LSA calculation circuit 121 calculates LSA to set the LSA to the temporary LSA register 122 (S104). After that in execution (EX3) phase of the loop instruction, the LEA calculation circuit 111 calculates LEA (S105). Then the LSA calculation circuit 121 sets LSA held in the temporary LSA register 122 to the LSA register 123. The LEA calculation circuit 111 sets the calculated LEA to the LEA register 113 (S106).

If the instruction is not a loop instruction in S101, or the interlock of S102 and after setting LSA/LEA, the loop end evaluation circuit 130 evaluates whether the instruction in the loop is currently processed (S107). If evaluated that the instruction in the loop is currently processed, the loop end evaluation circuit 130 performs a loop end evaluation by S108 or S109. Specifically, the loop end evaluation circuit 130 compares the PC value of the program counter 101 with LEA of the LEA register by the comparator 131 so as to evaluate whether they are equal or not (S108). If the PC value is equal to with LEA in S108, the loop end evaluation circuit 130 compares the LC value of the loop counter 102 with 0 by the comparator 132 so as to evaluate whether they are equal or not (S109). If the LC value is not 0 in S109, the loop end evaluation circuit 130 sets LSA of the LSA register 123 to the PC value of the program counter 101 (S110). Then the loop counter 102 decrements the LC value (S111).

If evaluated that the instruction in the loop is not currently processed in S107, if the PC value is not equal to LEA in S108, if the LC value is 0 in S109, the program counter 101 increments the PC value (S112).

An example in which each instruction is processed in pipeline by the processor 1 of this embodiment is described hereinafter in detail.

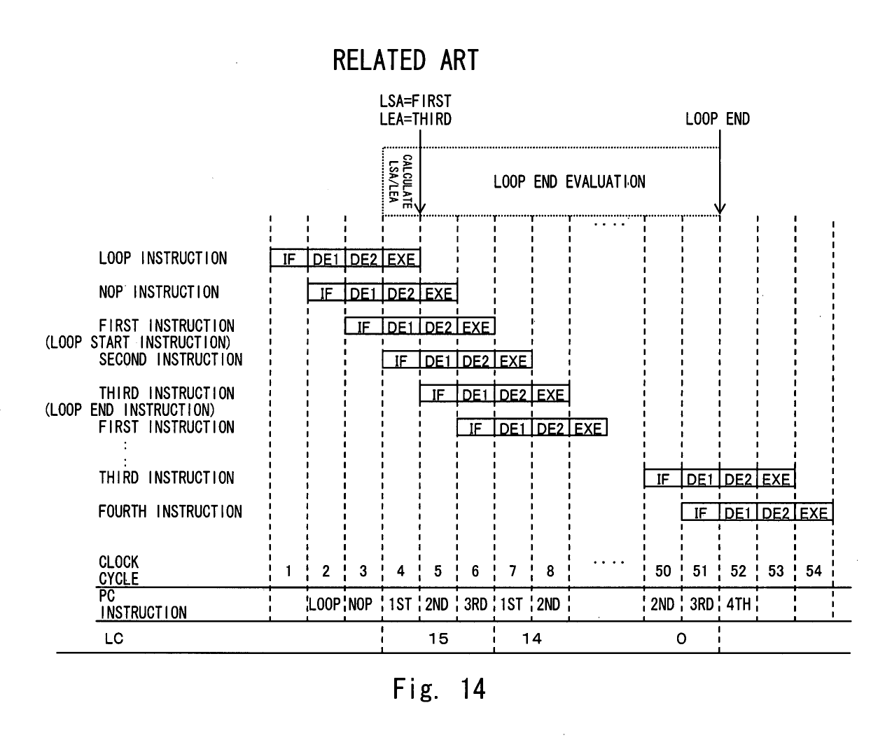

In this embodiment, the interlock is generated from the phase following the decode phase to the end of the execution phase of the loop instruction. Thus if applying the pipeline, in which the phase following the decode phase as with FIG. 10A, to the processor 1, the interlock is not generated and LSA/LEA are calculated and set in EXE phase. Therefore the operation is identical to FIG. 14.

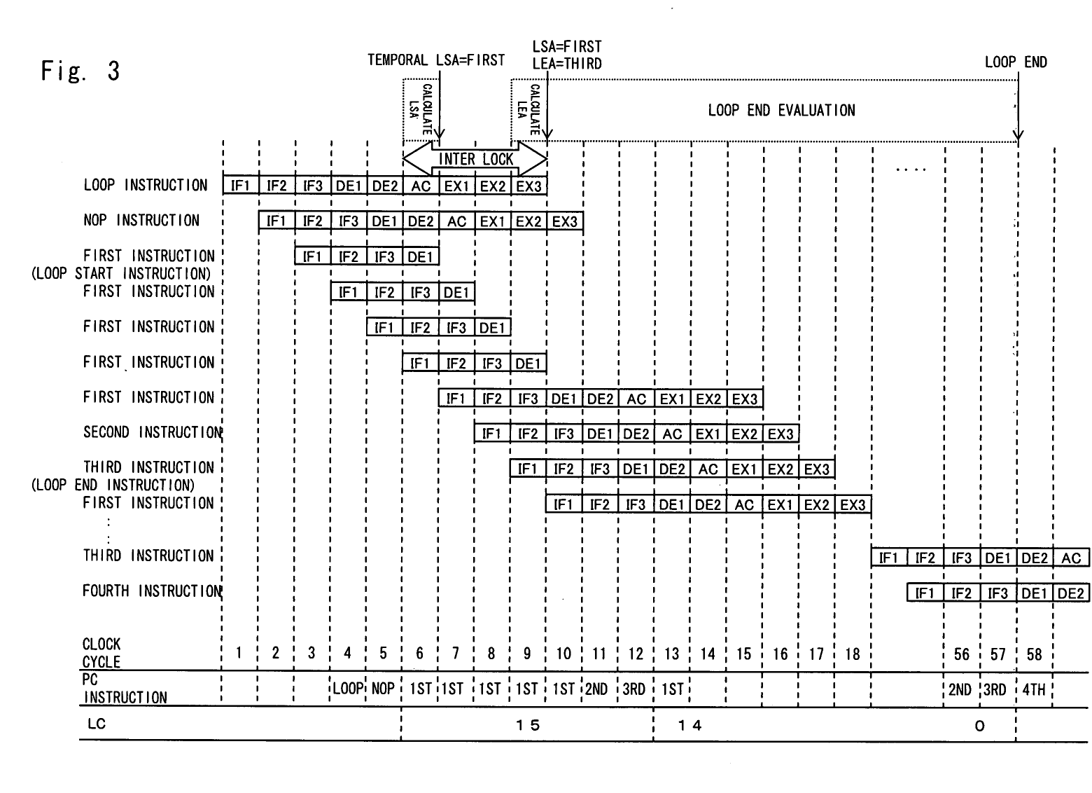

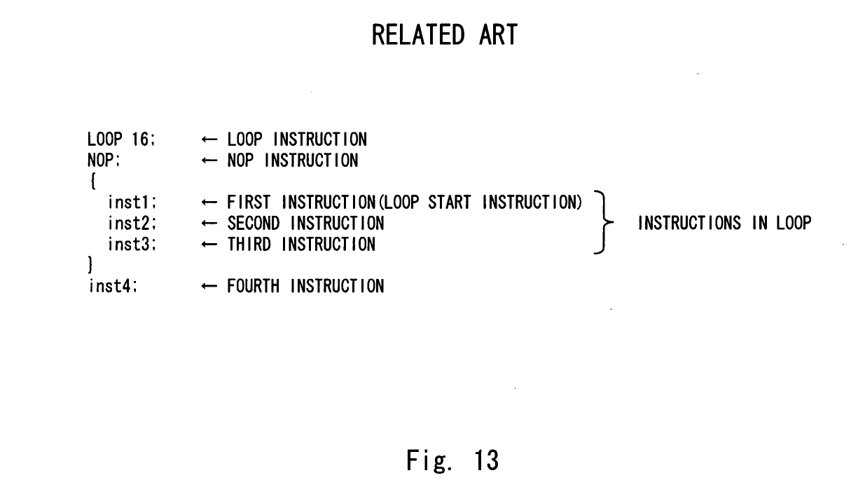

FIG. 3 is a pipeline process applied with the pipeline of FIG. 10B to the processor 1 and then executing the program of FIG. 13.

The pipeline of 9 phases, which are IF1 to IF3, DE1, DE2, AC, and EX1 to EX3 of the loop instruction are processed in clock cycles “1 to 9”. The pipeline of the NOP instruction is processed in clock cycle “2 to 10”, then the first to the third instructions are sequentially processed.

When the loop instruction is decoded in DE2 phase of the loop instruction in clock cycle “5”, an interlock is generated for 4 cycles from AC phase of the loop instruction in clock cycle “6” to EX3 phase of the loop instruction in clock cycle “6” (S102) Accordingly the pipeline process of the first instruction is suspended from clock cycle “6” to “9”. Thus the decoded phase (DE2 phase) of the first instruction is not processed.

LSA is calculated in AC phase of the loop instruction in clock cycle “6”, and then LSA is set to the temporary LSA register 122 at a timing when proceeding from the clock cycle “6” to “7”. LSA is the PC value in clock cycle “6”, specifically in AC phase of the loop instruction. This value is set to the temporary LSA register 122. The PC value in clock cycle “6” is an address of the first instruction due to one cycle delay by the NOP instruction. The address of the first instruction is LSA.

LEA is calculated in EX3 phase of the loop instruction in clock cycle “9” (S105). LEA is an address included in the machine language code of the loop instruction. In this example LEA is an address of the third instruction.

LSA/LEA are set to the LSA/LEA registers at a timing when proceeding from the clock cycle “9” to “10” (S106). Specifically, the address of the first instruction held to the temporary LSA register 122 as LSA is set to the LSA register 123. The address of the third instruction calculated as LEA is set to the LEA register 113.

After completing to execute the loop instruction in clock cycle “9”, the interlock is ended. Thus the pipeline process of the first instruction is resumed from clock cycle “10” to decode. Then after setting LSA/LEA, the loop end evaluation is performed.

The PC value is evaluated in clock cycle “11” (S108). As the PC value is the address of the second instruction that is not equal to LEA, the PC value is incremented (S112). The third instruction following the second instruction is decoded in clock cycle “12”.

The PC value is evaluated in clock cycle “12” (S108). As the PC value is the address of the third instruction that is equal to LEA, the LC value is evaluated (S109). As the LC value is not 0, the PC value is set as the address of the first instruction, which is LSA (S110). Then the LC value is decremented (S111), and the first instruction is decoded in clock cycle “13”.

When the pipeline process of the first to the third instructions is repeated for 16 times, the PC value is evaluated in clock cycle “57” (S108). As the PC value is the address of the third instruction that is equal to LEA, the LC value is evaluated (S109). Since the LC value is equal to 0, it is evaluated to be a loop end. Thus the PC value is incremented (S112), and the next instruction in the instructions in the loop, which is the fourth instruction, is decoded in clock cycle “58”.

In case of a maximum loop configuration in which the number of instructions in the loop is only one, the loop start instruction is equivalent to the loop end instruction. Thus until the execution of the loop instruction is completed, the execution of the loop end instruction (loop start instruction) is suspended.

As described in the foregoing, in this embodiment, by generating an interlock for the number of pipeline hazard generated due to a difference of pipeline phases even in a case where the number of pipeline phases is increased to improve operation frequency, the execution of the loop start instruction is suspended until the end of the execution phase of the loop instructions, thereby not performing the loop end evaluation before completing to execute the loop instruction. This enables to always execute the loop end instruction after completing to execute the loop instruction. Thus the loop end evaluation is accurately performed in order to repeat the instructions in the loop for the specified number of times.

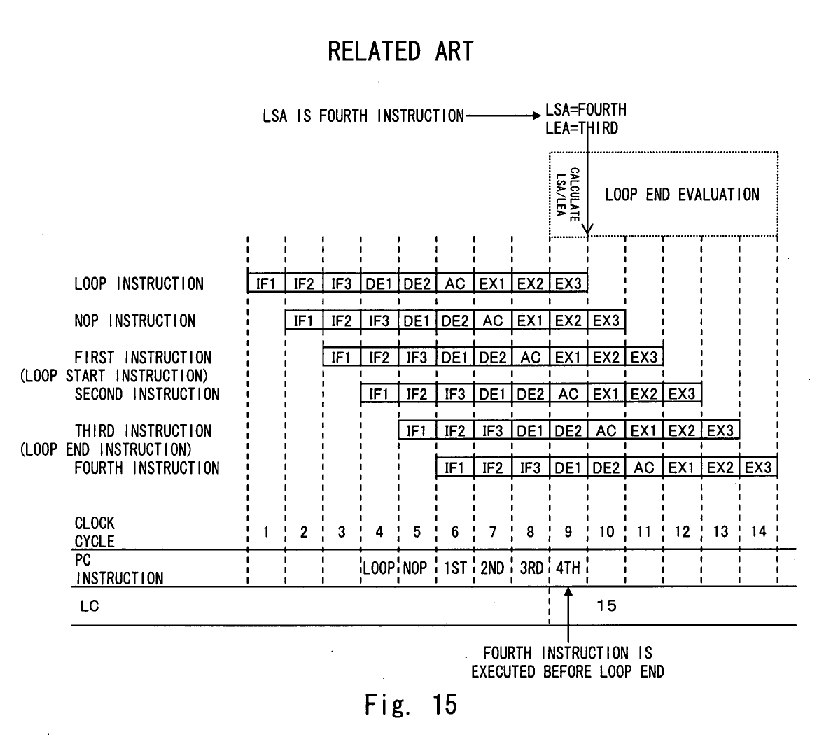

With the increased number of pipeline phases in the conventional example of FIG. 15, in EX3 phase of the loop instruction in clock cycle “9”, the NOP and the first to the third instructions are processed. The PC value is the next instruction in the instructions in the loop, which is the fourth instruction. Accordingly when setting the PC value at this time to LSA, the address of the fourth instruction is set instead of the address of the first instruction. That is, in the conventional technique, an address of an instruction after a loop start instruction is incorrectly set instead of a correct address of the loop start instruction. This causes to start repeating the instruction indicated by the incorrectly set LSA, when repeating the loop process, thereby disabling to repeatedly execute instructions from the actual LSA to the wrong LSA.

In this embodiment, by setting the LSA register after completing to execute the loop instruction after calculating LSA and holding LSA to the temporary LSA register in the phase following the decode phase of the loop instruction instead of the execution phase of the loop instruction, a correct LSA can be set as with before increasing the pipeline.

Therefore, when the number of pipeline phases is increased to improve the operation frequency, modifications is not required to the existing program such as adding an NOP instruction, thereby maintaining compatibility of software.

### Second Embodiment

A processor according to a second embodiment of the present invention is described hereinafter in detail. The processor of this embodiment interlocks only when the loop end instruction is executed before completing to execute the loop instruction so as to abort the execution of the loop end instruction and to execute the loop end instruction after executing the loop instruction.

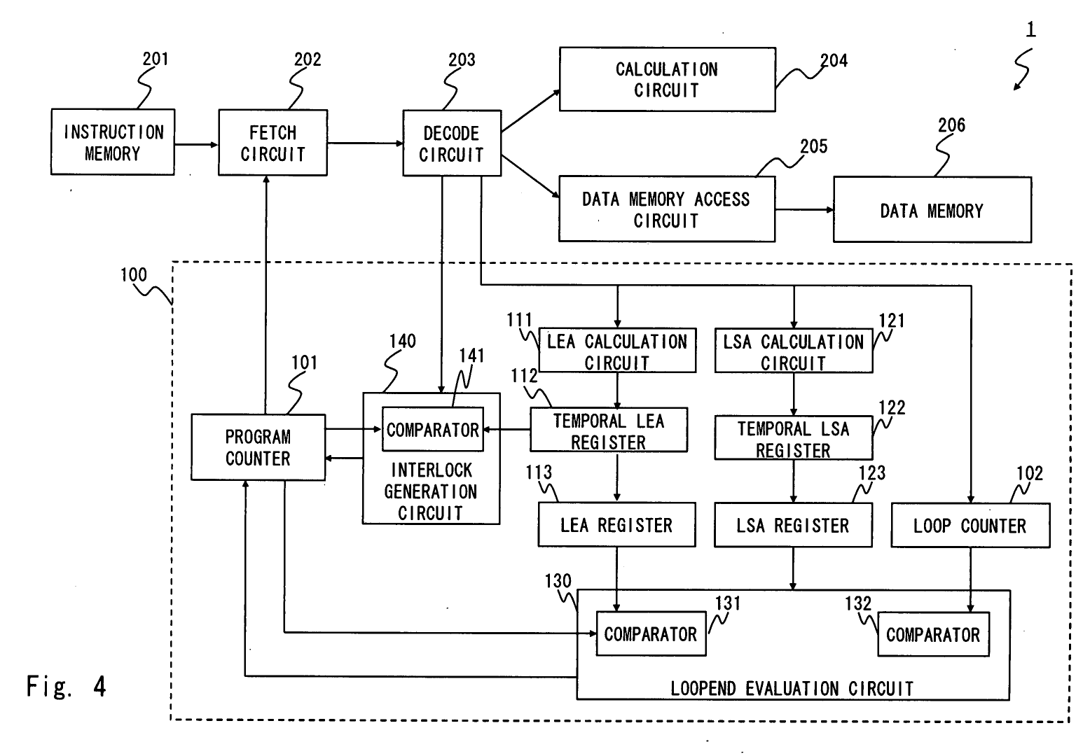

A configuration of the processor of this embodiment is described hereinafter in detail with reference to FIG. 4. In FIG. 4, components identical to those in FIG. 1 are identical to those therein. As shown in FIG. 4, a processor 1 further includes a temporary LEA register 112 in the loop control circuit 100 in addition to the configuration of FIG. 1.

In this embodiment, the LEA calculation circuit 121 calculates LSA before the execution phase of the loop instruction, specifically in a phase following the decode phase (i.e. AC phase) of the loop instruction. The calculation of LEA is not limited in AC phase, but may be any pipeline phase included in the pipeline phase of the loop instruction from the phase following the decode phase to the execution phase.

The temporary LEA register 112 holds LEA calculated by the LEA calculation circuit 111 till the execution phase of the loop instruction. The LEA register 113 holds LEA held by the temporary LEA register 112 after completing the execution phase of the loop instruction.

The interlock generation circuit 140 generates an interlock from the phase (AC phase) following the decode phase to the execution phase (EX3 phase) in the pipeline process of the loop instruction so as to suspend the pipeline process of the loop end instruction. Especially the interlock generation circuit 140 performs an interlock check before finishing the pipeline process of the loop instruction, specifically before the execution phase of the loop instruction so as to generate an interlock in a case the pipeline process of the loop end instruction is executed. The interlock check includes an evaluation whether the current process reaches the loop end instruction, specifically the PC value is equal to LEA. The comparator 141 compares the PC value with LEA of the temporary LEA register 112.

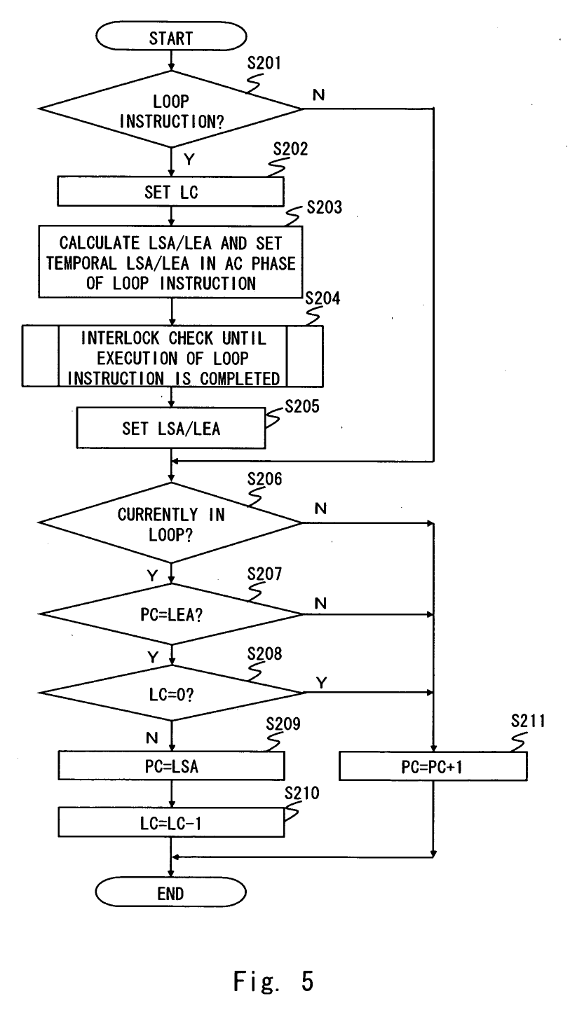

A loop control method by the processor of this embodiment is described hereinafter in detail with reference to FIG. 5. Firstly as with S101 of FIG. 2, the decode circuit 203 evaluates whether the decoded instruction is a loop instruction (S201).

If the decoded instruction is a loop instruction in S201, the loop counter 102 sets the number of loops specified by the loop instruction as the LC value (S202). Then in AC phase of the loop instruction, LSA calculation circuit 121 calculates LSA and sets the calculated LSA to the temporary LSA register 122. The LEA calculation circuit 111 calculates LEA and sets the calculated LEA to the temporary LEA register 112 (S203). After that, the interlock generation circuit 140 performs the interlock check until completing the execution of the loop instruction (S204).

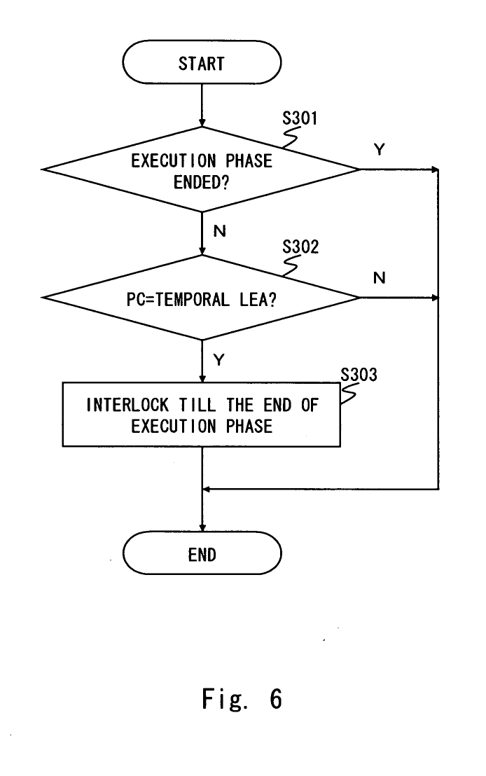

FIG. 6 is a view showing the interlock check process. In the interlock check process, the interlock generation circuit 140 evaluates the end of the execution of the loop instruction (S301).

If the execution phase of the loop instruction is not completed in S301, the interlock generation circuit 140 compares the PC value with LEA of the temporary LEA register 112 so as to evaluate whether they are equal or not (S302). The evaluation is repeated till the end of the execution phase.

If the PC value is equal to LEA in S302, the interlock generation circuit 140 generates an interlock till the end of the execution phase of the loop instruction (S303). This suspends the execution of the loop end instruction until the execution of the loop instruction is completed.

If the execution phase of the loop instruction is already completed in S301, or the PC value is not equal to LEA in S302, the interlock generation circuit 140 does not generate an interlock.

After completing the interlock check of S204, the LSA calculation circuit 121 sets LSA held to the temporary LSA register 122 to the LSA register 123. The LEA calculation circuit 111 sets LEA held to the temporary LEA register 112 to the LEA register 113 (S205).

After S206, as with after S107 in FIG. 2, the loop end evaluation is performed. Specifically if the instruction is not an loop instruction in S201, or after setting LSA/LSE in S205, it is evaluated whether the instructions in the loop are currently processed (S206). If the instructions in the loop are currently processed, the loop end evaluation is performed in S207 and S208. The loop end evaluation circuit 130 compares the PC value with LEA by the comparator 131 (S207). If the PC value is equal to LEA, the LC value is compared with 0 by the comparator 132 (S208). If the LC value is not equal to 0 in S208, the loop end evaluation circuit 130 sets LSA of the LSA register 123 to the PC value of the program counter 101 (S209). The loop counter 102 decrements the LC value (S210).

If the instructions in the loop are not executed in S206, if the PC value is not equal to LEA in S207, or if the LC value is equal to 0 in S208, the program counter 101 increments the PC value (S211).

An example in which each instruction is processed in pipeline by the processor 1 of this embodiment is described hereinafter in detail.

In this embodiment, an interlock is generated only when the loop end instruction is executed until the end of the execution phase of the loop instruction. Thus if applying the pipeline, in which the execution phase is of only one phase as with FIG. 10A, to the processor 1, the interlock is not generated and LSA/LEA are calculated and set in EXE phase. Therefore the operation is identical to FIG. 14.

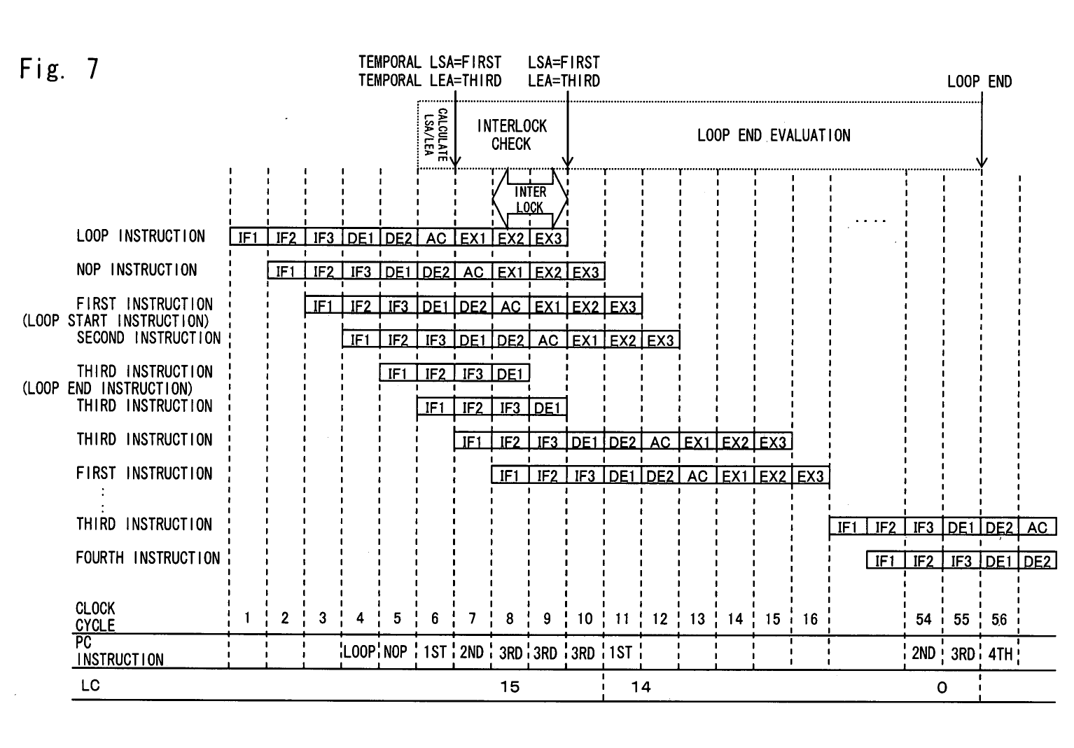

FIG. 7 is a pipeline process applied with the pipeline of FIG. 10B to the processor 1 and then executing the program of FIG. 13.

The pipeline of 9 phases, which are IF1 to IF3, DE1, DE2, AC, and EX1 to EX3 of the loop instruction are processed in clock cycles “1 to 9”. The pipeline of the NOP instruction is processed in clock cycle “2 to 10”, then the first to the third instructions are sequentially processed.

When the loop instruction is decoded in DE2 phase of the loop instruction in clock cycle “5”, LSA/LEA are calculated in AC phase of the loop instruction in clock cycle “6”, and LSA/LEA are set to the temporary LSA register 122/temporary LEA register 112 at a timing when proceeding from clock cycle “6” to “7” (S203) At this time as with the first embodiment, the LSA is the address of the first instruction, which is the PC value in clock cycle “6”. LEA is the address of the third instruction from the machine language code of the loop instruction.

Then an interlock check is performed from clock cycle “7” to “9”, in which the execution phase of the loop instruction is completed (S204). In the interlock check, the PC value and LEA of the temporary LEA register 112 are compared (S302). In clock cycle “7”, the PC value is the address of the second instruction that is not equal to LEA of the temporary LEA register 112. Thus the interlock is not generated and the second instruction is decoded. In clock cycle “8”, as the PC value is the address of the third instruction that is equal to LEA of the temporary LEA register 112, the interlock is generated until the execution of the loop instruction is completed (S303). Since the pipeline process of the third instruction is suspended from clock cycle “8” to “9”, the decode phase (DE2 phase) of the third instruction is not processed.

LSA/LEA are set to the LSA register 123/LEA register 113 at a timing when clock cycle proceeds from “9”to “10”(S205). Specifically, the address of the first instruction that is held to the temporary LSA register 122 as LSA is set to the LSA register 123, and the address of the third instruction held to the temporary LEA register 112 as LEA is set to the LEA register 113.

After completing to execute the loop instruction in clock cycle “9”, the interlock check is completed and the generated interlock ends. Thus the pipeline process of the third instruction is resumed from clock cycle “10”so as to decode. When LSA/LEA are set, the loop end evaluation is performed.

The PC value is evaluated in clock cycle “10” (S207). As the PC value is the address of the third instruction that is equal to LEA, the LC value is evaluated (S208). Since the LC value is not 0, the PC value is set to the address of the first instruction, which is LSA (S209). Then the LC value is decremented (S210), and the first instruction is decoded in clock cycle “11”.

If the pipeline processes from the first to the third instructions are repeated for 16 times, the PC value is evaluated in clock cycle “55” (S207). As the PC value is the address of the third instruction that is equal to LEA, the LC value is evaluated (S208). Since the LC value is equal to 0, it is a loop end and the PC value is incremented (S211). Then the next instruction in the instructions in the loop, which is the fourth instruction, is decoded in clock cycle “56”.

As described in the foregoing in this embodiment, the loop end instruction is interlocked only for necessary case and necessary period, specifically from when the loop end instruction is to be executed until the execution of the loop instruction is completed. Thus the period of the interlock can be reduced as compared to the first embodiment in which the loop start instruction is always interlocked.

An example of executing other programs by the processor 1 of this embodiment is described hereinafter in detail.

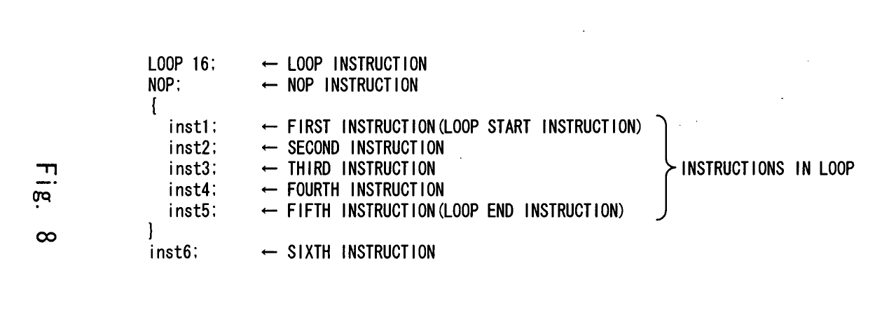

FIG. 8 is a view showing an example of a program executed here. In the example of FIG. 8, the loop and NOP instructions are written as with FIG. 13. Furthermore the instructions in the loop are from the first to fifth instructions, with an instruction following the instructions in the loop to be the sixth instruction. Specifically this program indicates to repeat executing the first to the fifth for 16 times, and then the sixth instruction.

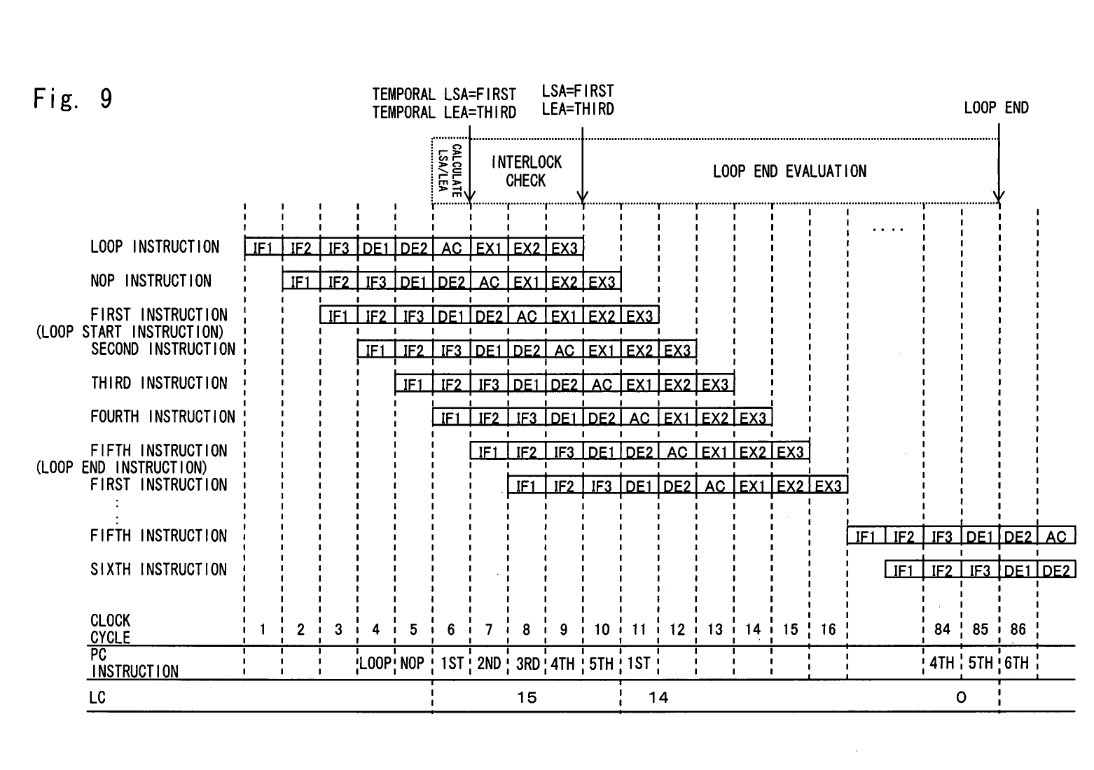

FIG. 9 is a pipeline process applied with the pipeline of FIG. 10B to the processor 1 and then executing the program of FIG. 8.

The pipeline of 9 phases, which are IF1 to IF3, DE1, DE2, AC, and EX1 to EX3 of the loop instruction are processed in clock cycles “1 to 9”. The pipeline of the NOP instruction is processed in clock cycle “2 to 10”, then the first to the fifth instructions are sequentially processed.

When the loop instruction is decoded in DE2 phase of the loop instruction in clock cycle “5”, LSA/LEA are calculated in AC phase of the loop instruction in clock cycle “6”, and LSA/LEA are set to the temporary LSA register 122/temporary LEA register 112 at a timing when proceeding from clock cycle “6” to “7” (S203). At this time as with FIG. 7, the LSA is the address of the first instruction, which is the PC value in clock cycle “6”. LEA is the address of the fifth instruction from the machine language code of the loop instruction.

The Pc value and LEA of the temporary LEA register 112 are compared form clock cycle “7” to “9”, in which the execution of the loop instruction is completed”, so as to perform the interlock check (S204).

As the PC value is the address of the second instruction that is not equal to the temporal LEA, the interlock is not generated and the second instruction is decoded. Since the Pc value is the address of the fourth instruction that is not equal to the temporal LEA in clock cycle “9”, the interlock is not generated and the fourth instruction is decoded.

The loop instruction is executed in clock cycle “9”. LSA of the temporary LSA register 122 and LEA of the temporary LEA register 112 are set to the LSA register 123 and the LEA register 113 at a timing the clock cycle proceeds from “9” to “10” (S205).

When the execution of the loop instruction is completed in clock cycle “9”, the interlock check is completed. Thus the interlock is not generated in this case. Further, the loop end evaluation is performed when LSA/LEA are set.

The PC value is evaluated in clock cycle “10” (S207). As the PC value is the address of the fifth instruction that is equal to LEA, LC value is evaluated (S208). Since the LC value is not equal to 0, the PC value is set to the address of the first instruction (S209). Then the LC value is decremented (S210), and the first instruction is decoded in clock cycle “11”.

When the pipeline processes from the first to the third instructions are repeated for 16 times, the PC value is evaluated in clock cycle “85” (S207). As the Pc value is the address of the fifth instruction that is equal to LEA, the LC value is evaluated (S208). Since the LC value is equal to 0, it is an loop end and the PC value is incremented (S211). Then the next instruction in the instructions in the loop, which is the sixth instruction, is decoded in clock cycle “86”.

As described in the foregoing, an interlock is not generated if not necessary. Thus a cycle efficiency can be improved as compared to the first embodiment where the loop start instruction is always interlocked.

As described in the foregoing, in this embodiment, by generating an interlock even in a case where the number of pipeline phases is increased to improve operation frequency, the execution of the loop end instruction is suspended until the end of the execution phase of the loop instruction, thereby not performing the loop end evaluation before completing to execute the loop instruction. This enables to always execute the loop end instruction after completing to execute the loop instruction. Thus the loop end evaluation is accurately performed in order to repeat the instructions in the loop for the specified number of times.

Furthermore, by comparing the PC value with the value of the temporary LEA register, an interlock is generated if the loop end instruction is to be executed before completing the execution of the loop instruction, and an interlock is not generated if the loop end instruction is not executed before completing the execution of the loop instruction. Thus the interlock period can be reduced as well as cycle performance can be improved as compared to a case in which an interlock is generated for a loop instruction without condition. If the program is nested, specifically there is a loop inside a loop, this advantageous effect of the reduced interlock period for the loop instruction can be obvious because the inner loop is repeatedly executed.

As with the first embodiment, as LSA is calculated in the phase following the decode phase of the loop instruction, LSA can accurately be set. Therefore, the existing program before increasing the number of phases in the pipeline is not required to be modified, thereby maintaining compatibility of software.

The present invention is not limited to the above embodiment and it maybe modified and changed without departing from the scope and spirit of the invention. For example, in the above embodiment, the execution of the instruction is suspended by the interlock, however it may be suspended by other method. In the above examples, the execution of the first or the loop end instruction is suspended. However an execution of other instructions of the instructions in the loop may be suspended. Furthermore in the above examples, LSA is not included in the instruction code but is calculated while executing the loop instruction. However LSA may be included in the instruction code as with LEA. Further, the processor is explained as the DSP, however it is not limited to this but may be other processors.

It is apparent that the present invention is not limited to the above embodiment and it may be modified and changed without departing from the scope and spirit of the invention.

What is claimed is:

1. A loop control circuit to control to repeatedly execute from a loop start instruction to a loop end instruction according to a loop instruction in a processor to process an instruction in a pipeline, the loop control circuit comprising:
an interlock generation circuit to suspend a pipeline process of the loop end instruction until a pipeline process of the loop instruction is completed;
a loop end evaluation circuit to take a loop end evaluation when the pipeline process of the loop end instruction is executed.

2. The loop control circuit according to claim 1, further comprising:
a program counter to sequentially indicate an address of an instruction to be processed in pipeline;
a loop start address calculation circuit to calculate a loop start address during the pipeline process of the loop instruction, the loop start address being an address of the loop start instruction;
a loop end address calculation circuit to calculate a loop end address during the pipeline process of the loop instruction, the loop end address being an address of the loop end instruction; and,
the loop end evaluation circuit sets the program counter to the loop start address according to a result of the comparison between the program counter and the loop end address after the pipeline process of the loop instruction is completed.

3. The loop control circuit according to claim 1, wherein the interlock generation circuit generates an interlock from a phase following a decode phase to a completion of an execution phase in the pipeline process of the loop instruction so as to suspend a pipeline process of the loop start instruction.

4. The loop control circuit according to claim 2, wherein the interlock generation circuit generates an interlock from a phase following a decode phase to a completion of an execution phase in the pipeline process of the loop instruction so as to suspend a pipeline process of the loop start instruction.

5. The loop control circuit according to claim 3, wherein the loop start address calculation circuit calculates the loop start address in a pipeline phase among pipeline phases included in the pipeline process of the loop instruction, the pipeline phase being the phase the address of the loop start instruction is set to the program counter.

6. The loop control circuit according to claim 4, wherein the loop start address calculation circuit calculates the loop start address in a pipeline phase among pipeline phases included in the pipeline process of the loop instruction, the pipeline phase being the phase the address of the loop start instruction is set to the program counter.

7. The loop control circuit according to claim 3, further comprising a loop start address register and a temporary loop start address register to hold the loop start address,
wherein the loop start address calculation circuit stores the calculated loop start address to the temporary loop start address register, and
the loop start address calculation circuit stores the loop start address stored to the temporary loop start address to the loop start address register at a completion of the pipeline process of the loop instruction.

8. The loop control circuit according to claim 1, wherein the interlock generation circuit generates an interlock from the phase following the decode phase to the completion of an execution phase in the pipeline process of the loop instruction so as to suspend a pipeline process of the loop end instruction.

9. The loop control circuit according to claim 2, wherein the interlock generation circuit generates an interlock from the phase following the decode phase to the completion of an execution phase in the pipeline process of the loop instruction so as to suspend a pipeline process of the loop end instruction.

10. The loop control circuit according to claim 8, wherein the interlock generation circuit generates an interlock if the pipeline process of the loop end instruction is executed before the completion of the pipeline process of the loop instruction.

11. The loop control circuit according to claim 9, wherein the interlock generation circuit generates an interlock if the pipeline process of the loop end instruction is executed before the completion of the pipeline process of the loop instruction.

12. The loop control circuit according to claim 8, further comprising a loop start address register and a temporary loop start address register to hold the loop start address, and a loop end address register and a temporary loop end address register to hold the loop end address,
wherein the loop start address calculation circuit stores the loop start address in a pipeline phase among the pipeline phases included in the pipeline process of the loop instruction to the temporary loop start address register, the loop start register being calculated
the loop start address calculation circuit stores the loop start address calculated in a pipeline phase among pipeline phases included in the pipeline process of the loop instruction, the pipeline phase being the phase the address of the loop start instruction is set to the program counter,
the loop end address calculation circuit stores the loop end address calculated in any of a pipeline phase from the phase following the decode phase to the execution phase among the pipeline phases included in the pipeline process of the loop instruction to the temporary loop end address register, and
wherein the loop start address calculation circuit stores the loop start address stored to the temporary loop start address to the loop start address register and the loop end address calculation circuit stores the loop end address stored to the temporary loop end address to the loop end address register at a completion of the pipeline process of the loop instruction.

13. The loop control circuit according to claim 10, further comprising a loop start address register and a temporary loop start address register to hold the loop start address, and a loop end address register and a temporary loop end address register to hold the loop end address,
wherein the loop start address calculation circuit stores the loop start address in a pipeline phase among the pipeline phases included in the pipeline process of the loop instruction to the temporary loop start address register, the loop start register being calculated
the loop start address calculation circuit stores the loop start address calculated in a pipeline phase among pipeline phases included in the pipeline process of the loop instruction, the pipeline phase being the phase the address of the loop start instruction is set to the program counter,
the loop end address calculation circuit stores the loop end address calculated in any of a pipeline phase from the phase following the decode phase to the execution phase among the pipeline phases included in the pipeline process of the loop instruction to the temporary loop end address register, and
wherein the loop start address calculation circuit stores the loop start address stored to the temporary loop start address to the loop start address register and the loop end address calculation circuit stores the loop end address stored to the temporary loop end address to the loop end address register at a completion of the pipeline process of the loop instruction.

14. A loop control circuit to control to repeatedly execute from a loop start instruction to a loop end instruction according to a loop instruction in a processor to process an instruction in a pipeline, the loop control circuit comprising:
a program counter to sequentially indicate an address of an instruction to be processed in pipeline;
a loop end address calculation circuit to calculate a loop end address, the loop end address being an address of the loop end instruction; and
an interlock generation circuit to generate an interlock according to a result of a comparison between the program counter and the loop end address until a completion of the pipeline process of the loop instruction so as to suspend the pipeline process of the loop end instruction.

15. The loop control circuit according to claim 14, comprising:
a loop start address calculation circuit to calculate the loop start address in a pipeline phase among pipeline phases included in the pipeline process of the loop instruction, the pipeline phase being the phase the address of the loop start instruction is set to the program counter; and
a loop end evaluation circuit to set the program counter to the loop start address according to a result of the comparison between the program counter and the loop end address after completing the pipeline process of the loop instruction.

16. The loop control circuit according to claim 14, wherein the interlock generation circuit generates an interlock if the calculated loop end address is equal to the program counter.

17. The loop control circuit according to claim 15, wherein the interlock generation circuit generates an interlock if the calculated loop end address is equal to the program counter.

18. A loop control method to control to repeatedly execute from a loop start instruction to a loop end instruction according to a loop instruction in a processor to process an instruction in a pipeline, the loop control method comprising:
generating an interlock to suspend a pipeline process of the loop end instruction until a pipeline process of the loop instruction is completed.

19. A loop control method according to claim 18, further comprising:
indicating sequentially an address of an instruction to be processed in pipeline by a program counter;
calculating a loop end address, the loop end address being an address of the loop end instruction,
the processing of generating an interlock is according to a result of the comparison between the program counter and the calculated loop end address.

20. The loop control method according to claim 19, further comprising generating an interlock if the calculated loop end address is equal to an address indicated by the program counter until a completion of the pipeline process of the loop instruction.
